(19) United States
(12) Patent Application Publication
(10) Pub. No.: US 2017/0367405 A1
(43) Pub. Date: Dec. 28, 2017

(54) CONNECTOR HAVING MULTIPLE THREADS AND ELECTRONIC CIGARETTES HAVING THE CONNECTOR

(71) Applicant: XIAOCHUN ZHU, SHENZHEN (CN)

(72) Inventor: XIAOCHUN ZHU, SHENZHEN (CN)

(21) Appl. No.: 15/194,535

(22) Filed: Jun. 27, 2016

(51) Int. Cl. A24F 47/00; H05B 3/12

(52) U.S. Cl. CPC A24F 47/008; H05B 3/12; H05B 2203/021

(57) ABSTRACT

Certain aspects of present invention relate to electronic cigarettes. In certain embodiments, the electronic cigarettes may include a vaporizer and e-liquid storage tank combo, and a power module. The vaporizer and e-liquid storage tank combo may include a heating element having a positive terminal and a negative terminal to receive electrical energy from a battery of the power module to heat e-liquid in direct contact with surfaces of a cylindrical vaporizer and a vaporizer connector having a circular base and the circular base having an external multiple threads connector. The power module may have a power connector having the battery, a positive terminal, a negative terminal, and an internal multiple threads connector. The external multiple threads connector of the vaporizer and e-liquid storage tank combo is threadedly connected to the internal multiple threads connector of the power connector of the power module.

### FIELD

The present invention generally relates to the field of electronic cigarette, and more particularly to a multiple threads connector between a vaporizer and a power module, and electronic cigarettes having multiple threads connector between the vaporizer and the power module.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is well known that smoking cigarette is harmful to smoker's health. The active ingredient in a cigarette is mainly nicotine. During smoking, nicotine, along with tar aerosol droplets produced in the cigarette burning, are breathed into the alveolus and absorbed quickly by the smoker. Once nicotine is absorbed into the blood of the smoker, nicotine then produces its effect on the receptors of the smoker's central nervous system, causing the smoker relax and enjoy an inebriety similar to that produced by an exhilarant.

The electronic cigarette is sometimes referred as electronic vaporing device, personal vaporizer (PV), or electronic nicotine delivery system (ENDS). It is a battery-powered device which simulates tobacco smoking. It generally uses a heating element that vaporizes a liquid solution (e-liquid). Some solutions contain a mixture of nicotine and a variety of flavorings, while others release a flavored vapor without nicotine. Many are designed to simulate smoking experience, such as cigarette smoking or cigar smoking. Some of them are made with similar appearance, while others are made considerably different in appearance.

Conventional electronic cigarettes have a single thread screw to connect a vaporizer portion and a power module portion. One of the drawback of using single thread screw connection is that it take a long time to disconnect the power module for recharging the power module, and reconnect the power module back to the electronic cigarette vaporizer portion.

Therefore, an unaddressed need exists in the art to address the aforementioned deficiencies and inadequacies.

### SUMMARY

In one aspect, the present disclosure relates to a vaporizer and e-liquid storage tank combo. In certain embodiments, the vaporizer and e-liquid storage tank combo may include: a circular vaporizer mounting base, a heating element, a cylindrical e-liquid medium, a cylindrical e-liquid storage tank body, a vaporizer connector, a vaporizer negative terminal contact, and a vaporizer positive terminal contact. The heating element may heat e-liquid in direct contact with surfaces of a cylindrical vaporizer. The heating element may include a positive terminal and a negative terminal. The cylindrical e-liquid medium is positioned inside the circular vaporizer mounting base for providing e-liquid in the cylindrical e-liquid storage tank body to the heating element of the cylindrical vaporizer.

In certain embodiments, the vaporizer connector may have a circular base, and the circular base may include an external multiple threads connector and a circular groove. The vaporizer negative terminal contact may electrically couple to the external multiple threads connector for connecting to a negative terminal of a power module and the negative terminal of the heating element. The vaporizer positive terminal contact may electrically couple to a positive terminal of the power module and the positive terminal of the heating element.

In another aspect, the present disclosure may include a power module. In certain embodiments, the power module may include a power connector. The power connector may be used to connect the power module to a vaporizer and e-liquid storage tank combo of an electronic cigarette. The power connector may include a positive terminal, a negative terminal, and an internal multiple threads connector. The positive terminal may be used to electrically couple to a positive terminal of a battery of the power module. The negative terminal may be used to electrically couple to a negative terminal of the battery of the power module. The internal multiple threads connector may include multiple threads for threadedly connecting a corresponding external multiple threads connector of the vaporizer and e-liquid storage tank combo of the electronic cigarette. The positive terminal of the power connector may be electrically coupled to a positive terminal of the vaporizer and e-liquid storage tank combo of the electronic cigarette, and the negative terminal of the power connector may be electrically coupled to a negative terminal of the vaporizer and e-liquid storage tank combo of the electronic cigarette.

In certain embodiments, the internal multiple threads connector of the power connector may include more than one individual threads. In one embodiment, the internal multiple threads connector of the power connector may have two individual threads. In another embodiment, the internal multiple threads connector of the power connector may have three or four individual threads such that the connection between the power module and the vaporizer and e-liquid storage tank combo can be made much quicker.

In yet another aspect, the present disclosure relates to an electronic cigarette. In certain embodiments, the electronic cigarette may include a vaporizer and e-liquid storage tank combo, and a power module.

In certain embodiments, the vaporizer and e-liquid storage tank combo may include a heating element and a vaporizer connector. The heating element may have a positive terminal and a negative terminal, and the heating element may be used to receive electrical energy from a battery of the power module through the positive terminal and the negative terminal to heat e-liquid in direct contact with surfaces of a cylindrical vaporizer. The vaporizer connector may include a circular base. The circular base may include an external multiple threads connector and a circular groove.

In certain embodiments, the power module may have a power connector. The power connector may include the battery, a positive terminal, a negative terminal, and an internal multiple threads connector. The power module may be used to provide the electrical energy of the battery to the vaporizer and e-liquid storage tank combo through the positive terminal and the negative terminal using the internal multiple threads connector. The external multiple threads connector of the vaporizer and e-liquid storage tank combo is threadedly connected to the internal multiple threads connector of the power connector of the power module.

In certain embodiments, the vaporizer and e-liquid storage tank combo may also include: a circular vaporizer mounting base, a cylindrical e-liquid storage tank body, a cylindrical e-liquid medium, a vaporizer negative terminal contact, and a vaporizer positive terminal contact. E-liquid used the electronic cigarette may be stored in the cylindrical e-liquid storage tank body. The cylindrical e-liquid medium may be positioned inside the circular vaporizer mounting base for providing e-liquid in the cylindrical e-liquid storage tank body to the heating element of the cylindrical vaporizer. The vaporizer negative terminal contact of the vaporizer and e-liquid storage tank combo may be electrically coupled to the external multiple threads connector for connecting the negative terminal of the power connector of the power module, and the negative terminal of the heating element. The vaporizer positive terminal contact of the vaporizer and e-liquid storage tank combo may be electrically coupled to a positive terminal of the power connector of the power module, and the positive terminal of the heating element.

In certain embodiments, the vaporizer and e-liquid storage tank combo may include a sealing ring positioned between the cylindrical e-liquid storage tank body and the circular groove of the vaporizer connector. The vaporizer and e-liquid storage tank combo may include a vaporizer insulation tube positioned between the vaporizer negative terminal contact and the vaporizer positive terminal contact for providing insulation between the vaporizer negative terminal contact and the vaporizer positive terminal contact. In certain embodiments, each of the external multiple threads connector of the vaporizer connector and the internal multiple threads connector of the power connector comprises more than one individual threads. The external multiple threads connector of the vaporizer connector and the internal multiple threads connector of the power connector have the same number of individual threads.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the invention, and wherein:

FIG. 1A is an external view of an exemplary electronic cigarette having multi-thread connector between a vaporizer and e-liquid storage tank combo and a power module, and FIG. 1B is an external view of the exemplary electronic cigarette with the vaporizer and e-liquid storage tank combo and the power module detached showing the multi-thread connector according to certain embodiments of the present invention;

FIG. 2A is an external view of a vaporizer and e-liquid storage tank combo having an external multiple threads connector, and FIG. 2B is a cross-sectional view of the vaporizer and e-liquid storage tank combo having the external multiple threads connector according to certain embodiments of the present invention;

FIG. 3A is an external view of a top portion of the power module, and FIG. 3B is a cross-sectional view of the top portion of the power module having an internal multiple threads connector according to certain embodiments of the present invention;

FIG. 4 is a detailed cross-sectional view of the external multiple threads connector and the power module connected through the external multiple threads connector of the vaporizer and e-liquid storage tank combo and the internal multiple threads connector of the power module according to certain embodiments of the present invention; and

FIG. 5 is an exploded perspective view of the vaporizer and e-liquid storage tank combo and the power module connected through the external multiple threads connector of the vaporizer and e-liquid storage tank combo and the internal multiple threads connector of the power module according to certain embodiments of the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top,” and “front” or “back” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximates, meaning that the term “around”, “about” or “approximately” can be inferred if not expressly stated.

Many specific details are provided in the following descriptions to make the present invention be fully understood, but the present invention may also be implemented by using other manners different from those described herein, so that the present invention is not limited by the specific embodiments disclosed in the following.

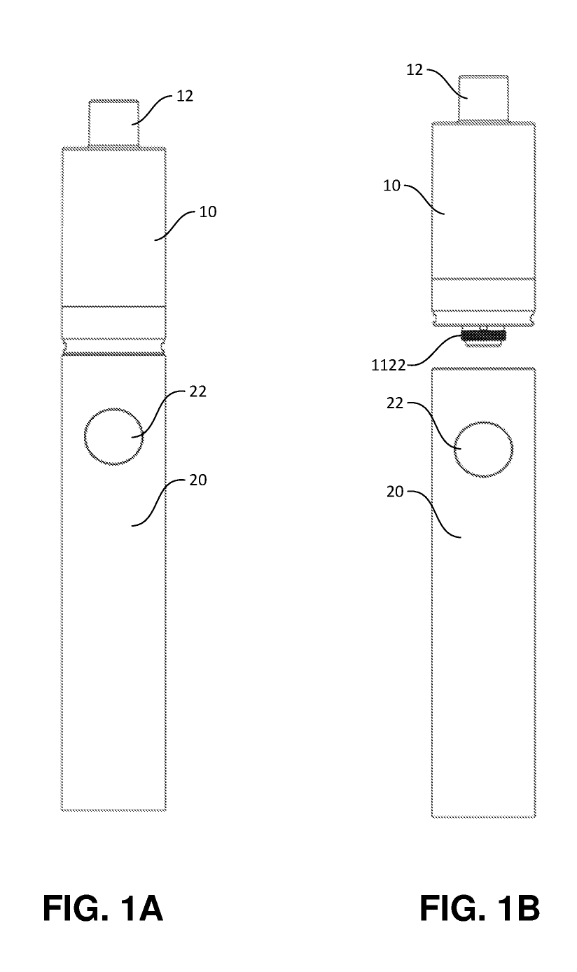

The description will be made as to the embodiments of the present invention in conjunction with the accompanying drawings FIGS. 1 through 5. FIG. 1A is an external view of an exemplary electronic cigarette having multi-thread connector between a vaporizer portion and a power module, and FIG. 1B is an external view of the exemplary electronic cigarette with the vaporizer portion and power module detached showing the multi-thread connector according to certain embodiments of the present invention. In certain embodiments, the electronic cigarette may include a vaporizer and e-liquid storage tank combo 10 and a power module 20. The vaporizer and e-liquid storage tank combo 10 may include a mouthpiece 12, a vaporizer and an e-liquid storage tank body (not shown in FIGS. 1A and 1B), and an external multiple threads connector 1122 of the vaporizer and e-liquid storage tank combo 10. The power module 20 may include a battery inside the power module 20 (not shown in FIGS. 1A and 1B), a push button switch 22, and an internal multiple threads connector of the power module 20 (not shown in FIGS. 1A and 1B). The vaporizer and e-liquid storage tank combo 10 may be connected through the external multiple threads connector 1122 of the vaporizer and e-liquid storage tank combo 10 to the internal multiple threads connector of the power module 20. When the battery is in need of charging, the vaporizer and e-liquid storage tank combo 10 is detached from the power module 20. When the battery is charged, the vaporizer and e-liquid storage tank combo 10 can be attached to the power module 20 using the external multiple threads connector 1122 of the vaporizer and e-liquid storage tank combo 10 and the internal multiple threads connector of the power module 20.

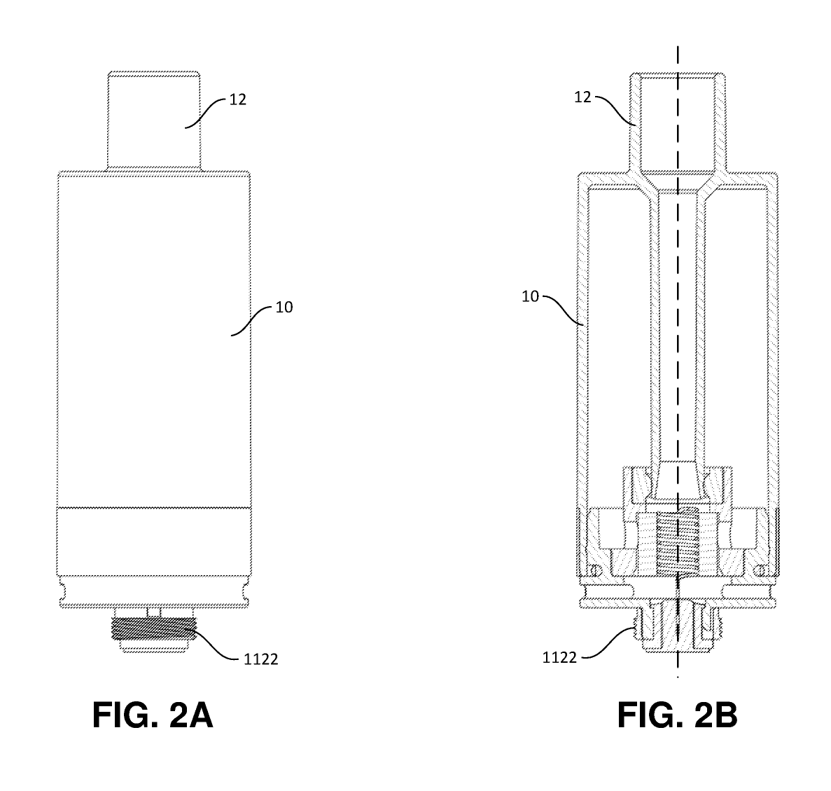

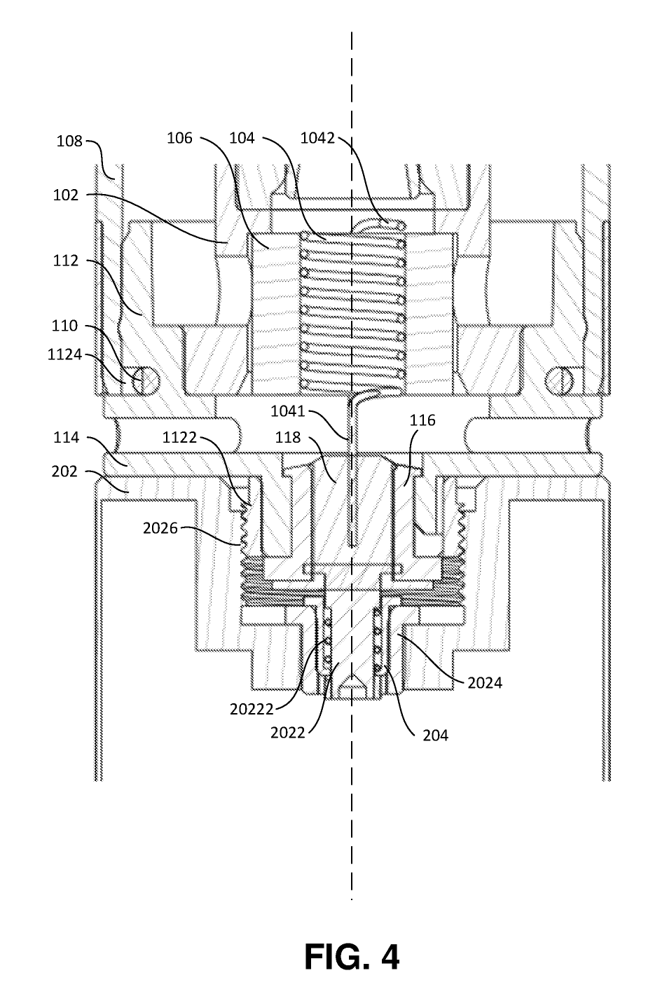

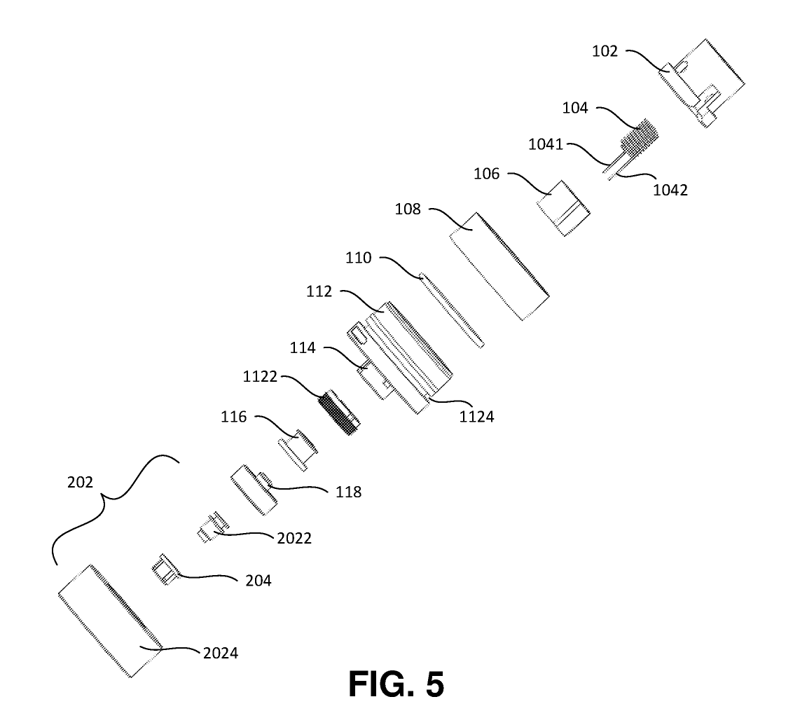

In one aspect, the present disclosure relates to the vaporizer and e-liquid storage tank combo 10 as shown in FIGS. 2A and 2B, and FIGS. 4 and 5. FIG. 2A is an external view of the vaporizer and e-liquid storage tank combo 10 having the external multiple thread connector 1122, and FIG. 2B is a cross-sectional view of the vaporizer and e-liquid storage tank combo 10 showing the external multiple thread connector 1122. FIG. 4 is a detailed cross-sectional view of the vaporizer and e-liquid storage tank combo 10 and the power module 20 connected through the external multiple threads connector 1122 of the vaporizer and e-liquid storage tank combo 10 and the internal multiple threads connector of the power module 20. FIG. 5 is an exploded perspective view of the vaporizer and e-liquid storage tank combo 10 and the power module 20.

In certain embodiments, the vaporizer and e-liquid storage tank combo 10 may include: a circular vaporizer mounting base 102, a heating element 104, a cylindrical e-liquid medium 106, a cylindrical e-liquid storage tank body 108, a vaporizer connector 112, a vaporizer negative terminal contact 114, and a vaporizer positive terminal contact 118. The heating element 104 may be used to heat e-liquid in direct contact with surfaces of a cylindrical vaporizer (partially shown in FIGS. 4 and 5). The heating element 104 may include a positive terminal 1041 and a negative terminal 1042. The cylindrical e-liquid medium 106 is positioned inside the circular vaporizer mounting base 102 for providing e-liquid in the cylindrical e-liquid storage tank body 108 to the heating element 104 of the cylindrical vaporizer.

In certain embodiments, the vaporizer connector 112 may have a circular base, and the circular base may include an external multiple threads connector 1122 and a circular groove 1124. The vaporizer negative terminal contact 114 may electrically couple to the external multiple threads connector 1122 for connecting to a negative terminal of a power module 20 and the negative terminal 1042 of the heating element 104. The vaporizer positive terminal contact 118 may electrically couple to a positive terminal of the power module 20 and the positive terminal 1041 of the heating element 104.

In certain embodiments, the vaporizer and e-liquid storage tank combo 10 may include a sealing ring 110. The sealing ring 110 may be positioned between the cylindrical e-liquid storage tank body 108 and the circular groove 1124 of the vaporizer connector 112 to prevent e-liquid leaking from the cylindrical e-liquid storage tank body 108.

In certain embodiments, the vaporizer and e-liquid storage tank combo 10 may include a vaporizer insulation tube 116. The vaporizer insulation tube 116 may be positioned between the vaporizer negative terminal contact 114 and the vaporizer positive terminal contact 118 for providing insulation between the vaporizer negative terminal contact 114 and the vaporizer positive terminal contact 118.

In certain embodiments, the external multiple threads connector 1122 of the vaporizer connector 112 may have more than one individual threads. In one embodiment, the external multiple threads connector 1122 of the vaporizer connector 112 may have two individual threads. In another embodiment, the external multiple threads connector 1122 of the vaporizer connector 112 may have three or four individual threads such that the connection between the vaporizer and e-liquid storage tank combo 10 and a power module can be made much quicker.

In certain embodiments, the cylindrical vaporizer may include a ceramic vaporizer.

In certain embodiments, the heating element 104 is embedded inside the cylindrical vaporizer. The heating element 104 may include one or more heating elements. The one or more heating elements are configured to heat e-liquid stored in the e-liquid storage device and the e-liquid is in direct contact with the exterior surface of the cylindrical vaporizer. The e-liquid is heated through the exterior surface of the cylindrical vaporizer. This configuration avoid direct contact between e-liquid and heating elements and it may prevent burning smell when the e-liquid makes direct contact with the heating elements. The one or more heating elements are totally covered by the ceramic material and therefore it is safe and may prevent short circuit. The cylindrical vaporizer is formed in much higher temperature than it is actually used in the electronic cigarette, therefore it is safe to use. The heat is transferred evenly on the surface of the cylindrical vaporizer. On one hand, the heating elements heat the cylindrical vaporizer quickly. On the other hand, the cylindrical vaporizer may be cooled quickly as well. The heating element 104 is not exposed to air so that the heating element 104 is prevented from oxidation. This configuration also prolongs the life of the cylindrical vaporizer and its heating element 104.

In certain embodiments, the one or more heating elements may include: Aluminum (Al), Chromium (Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium (Cd), Tantalum (Ta), Tungsten (W), Iridium (Ir), Platinum (Pt), Gold (Au), and alloys of these elements.

In certain embodiments, the one or more heating elements may include certain electrothermal alloys such as Nickel Chromium alloys, OCr25AL5, OCr27AL7MO2, OCr21AL6Nb, Cr15Ni60, Cr20Ni80, and Ocr19AL3 etc.

In one embodiment, the one or more heating elements may include heating wires wounded in mesh form. In another embodiment, the one or more heating elements may include heating wires wounded in spiral form.

In certain embodiments, each of the one or more heating elements may include a positive terminal 1041 configured to connect to the positive terminal of the battery of the power module 20, and a negative terminal 1042 configured to connect to the negative terminal of the battery of the power module 20.

In certain embodiments, the e-liquid medium 106 may include: cotton fibers, polypropylene fibers, terylene fibers, nylon fibers, porous ceramic materials, and any combination of these materials.

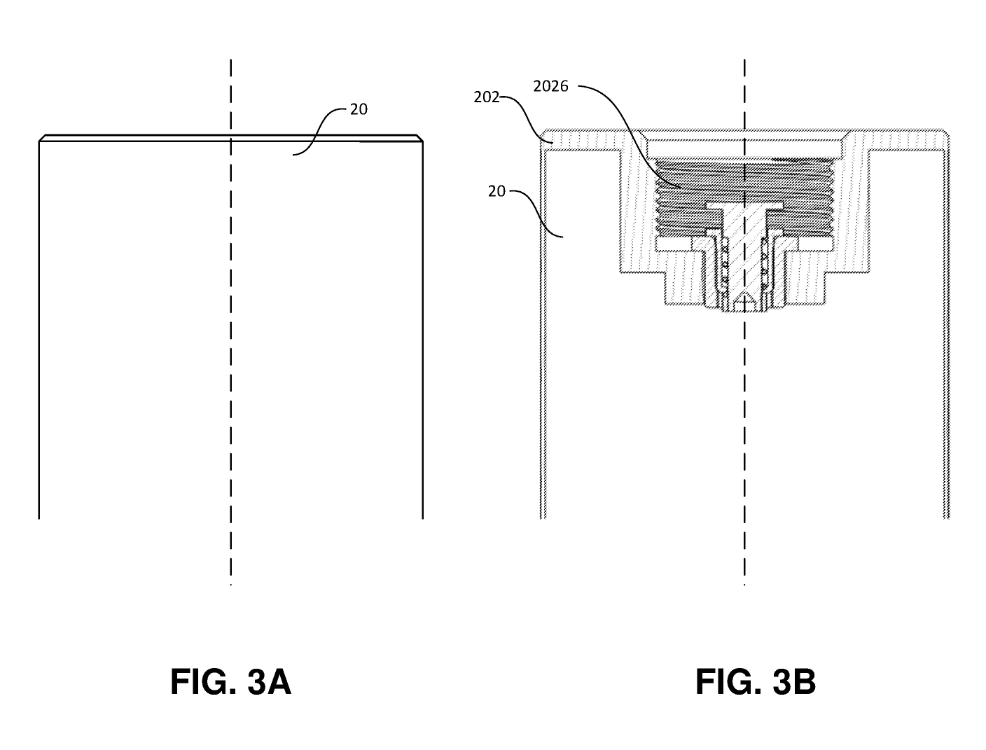

In another aspect, the present disclosure relates to a power module 20 as shown in FIGS. 3A and 3B, and FIGS. 4 and 5. In certain embodiments, the power module 20 may include a power connector 202. The power connector 202 may be used to connect the power module to a vaporizer and e-liquid storage tank combo of an electronic cigarette. The power connector 202 may include a positive terminal 2022, a negative terminal 2024, and an internal multiple threads connector 2026. The positive terminal 2022 may be used to electrically couple to a positive terminal of a battery of the power module 20. The negative terminal 2024 may be used to electrically couple to a negative terminal of the battery of the power module 20. The internal multiple threads connector 2026 may include multiple threads for threadedly connecting a corresponding external multiple threads connector of the vaporizer and e-liquid storage tank combo. The positive terminal 2022 of the power connector 202 may be electrically coupled to a positive terminal of a vaporizer and e-liquid storage tank combo, and the negative terminal 2024 of the power connector 202 may be electrically coupled to a negative terminal of the vaporizer and e-liquid storage tank combo.

In certain embodiments, the internal multiple threads connector 2026 of the power connector 202 may include more than one individual threads. In one embodiment, the internal multiple threads connector 2062 of the power connector 202 may have two individual threads. In another embodiment, the internal multiple threads connector 2062 of the power connector 202 may have three or four individual threads such that the connection between the power module 20 and the vaporizer and e-liquid storage tank combo can be made much quicker.

In certain embodiments, the power module 20 may include a power connector insulation tube 204. The power connector insulation tube 204 is positioned between the positive terminal 2022 of the power connector 202 and the negative terminal 2024 of the power connector 202 for providing insulation between the positive terminal 2022 of the power connector 202 and the negative terminal 2024 of the power connector 202.

In certain embodiments, the power module 20 may include a positive terminal spring 20222 of the power connector 202. The positive terminal spring 20222 of the power connector 202 is placed under the positive terminal 2022 of the power connector 202 for pushing the positive terminal 2022 of the power connector 202 upwards and to make secure contact between the positive terminal 2022 of the power connector 202 and the positive terminal of the vaporizer and e-liquid storage tank combo.

In yet another aspect, the present disclosure relates to an electronic cigarette as shown in FIGS. 1 through 5. In certain embodiments, the electronic cigarette may include a vaporizer and e-liquid storage tank combo 10, and a power module 20.

In certain embodiments, the vaporizer and e-liquid storage tank combo 10 may include a heating element 104 and a vaporizer connector 112. The heating element 104 may have a positive terminal 1041 and a negative terminal 1042, and the heating element 104 may be used to receive electrical energy from a battery of the power module through the positive terminal 1041 and the negative terminal 1042 to heat e-liquid in direct contact with surfaces of a cylindrical vaporizer. The vaporizer connector 112 may include a circular base. The circular base may include an external multiple threads connector 1122 and a circular groove 1124.

In certain embodiments, the power module 20 may have a power connector 202. The power connector 202 may include the battery, a positive terminal 2022, a negative terminal 2024, and a multiple internal treads connector 2026. The power module 20 may be used to provide the electrical energy of the battery to the vaporizer and e-liquid storage tank combo 10 through the positive terminal 2022 and the negative terminal 2024 using the multiple internal treads connector 2026. The multiple external treads connector 1122 of the vaporizer and e-liquid storage tank combo 10 is threadedly connected to the multiple internal treads connector 2026 of the power connector 202 of the power module 20.

In certain embodiments, the vaporizer and e-liquid storage tank combo 10 may also include: a circular vaporizer mounting base 102, a cylindrical e-liquid storage tank body 108, a cylindrical e-liquid medium 106, a vaporizer negative terminal contact 114, and a vaporizer positive terminal contact 118. E-liquid used the electronic cigarette may be stored in the cylindrical e-liquid storage tank body 108. The cylindrical e-liquid medium 106 may be positioned inside the circular vaporizer mounting base 102 for providing e-liquid in the e-liquid storage tank body 108 to the heating element 104 of the cylindrical vaporizer. The vaporizer negative terminal contact 114 of the vaporizer and e-liquid storage tank combo 10 may be electrically coupled to the external multiple threads connector 1122 for connecting the negative terminal 2024 of the power connector 202 of the power module 20, and the negative terminal 1042 of the heating element 104. The vaporizer positive terminal contact 118 of the vaporizer and e-liquid storage tank combo 10 may be electrically coupled to a positive terminal 2022 of the power connector 202 of the power module 20, and the positive terminal 1041 of the heating element 104.

In certain embodiments, the vaporizer and e-liquid storage tank combo 10 may include a sealing ring 110 positioned between the cylindrical e-liquid storage tank body 108 and the circular groove 1124 of the vaporizer connector 112. The vaporizer and e-liquid storage tank combo 10 may include a vaporizer insulation tube 116 positioned between the vaporizer negative terminal contact 114 and the vaporizer positive terminal contact 118 for providing insulation between the vaporizer negative terminal contact 114 and the vaporizer positive terminal contact 118. In certain embodiments, each of the external multiple threads connector 1122 of the vaporizer connector 112 and the multiple internal treads connector 2026 of the power connector 202 comprises more than one individual threads. The external multiple threads connector 1122 of the vaporizer connector 112 and the multiple internal treads connector 2026 of the power connector 202 have the same number of individual threads.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims, the foregoing description and the exemplary embodiments described therein, and accompanying drawings.

What is claimed is:

1. A vaporizer and e-liquid storage tank combo, comprising:
a circular vaporizer mounting base;
a heating element configured to heat e-liquid in direct contact with surfaces of a cylindrical vaporizer, wherein the heating element comprises a positive terminal and a negative terminal;
a cylindrical e-liquid storage tank body adapted for storing e-liquid therein;
a cylindrical e-liquid medium disposed inside the circular vaporizer mounting base for providing e-liquid in the cylindrical e-liquid storage tank body to the heating element of the cylindrical vaporizer;
a vaporizer connector having a circular base, wherein the circular base comprises an external multiple threads connector and a circular groove;
a vaporizer negative terminal contact electrically coupled to the external multiple threads connector for connecting a negative terminal of a power module, and the negative terminal of the heating element; and
a vaporizer positive terminal contact electrically coupled to a positive terminal of the power module, and the positive terminal of the heating element.

2. The vaporizer and e-liquid storage tank combo of claim 1, further comprising a sealing ring disposed between the cylindrical e-liquid storage tank body and the circular groove of the vaporizer connector to prevent e-liquid leaking from the cylindrical e-liquid storage tank body.

3. The vaporizer and e-liquid storage tank combo of claim 1, further comprising a vaporizer insulation tube disposed between the vaporizer negative terminal contact and the vaporizer positive terminal contact for providing insulation between the vaporizer negative terminal contact and the vaporizer positive terminal contact.

4. The vaporizer and e-liquid storage tank combo of claim 1, wherein the cylindrical vaporizer comprises a ceramic vaporizer.

5. The vaporizer and e-liquid storage tank combo of claim 1, wherein the external multiple threads connector of the vaporizer connector comprises more than one individual threads.

6. The vaporizer and e-liquid storage tank combo of claim 1, wherein the heating element comprises:
one or more mesh heating elements; and
one or more spiral heating elements.

7. The vaporizer and e-liquid storage tank combo of claim 1, wherein the heating element comprises:
aluminum (Al);
Chromium(Cr);
Manganese (Mn);
Iron (Fe);
Cobalt (Co);
Nickel (Ni);
Copper (Cu);
Zirconium (Zr);
Niobium (Nb);
Molybdenur (Mo);
Rhenium (Re);
Silver (Ag);
Cadmium(Cd);
Tantalum (Ta);
Tungsten (W);
Iridium (Ir);
Platinum (Pt);
Gold (Au); and
alloys thereof.

8. The vaporizer and e-liquid storage tank combo of claim 1, wherein the cylindrical e-liquid medium comprises:
cotton fibers;
polypropylene fibers;
terylene fibers;
nylon fibers;
porous ceramic materials; and
combination thereof.

9. A power module comprising:
a power connector configured to connect to a vaporizer connector of an electronic cigarette, wherein the power connector comprises:
a positive terminal electrically coupled to a positive terminal of a battery;
a negative terminal electrically coupled to a negative terminal of the battery; and
an internal multiple threads connector configured to threadedly connect to a corresponding external multiple threads connector of the vaporizer connector and electrically couple the positive terminal of the power connector to a positive terminal of the vaporizer connector, and the negative terminal of the power connector to a negative terminal of the vaporizer connector.

10. The power module of claim 9, wherein the internal multiple threads connector of the power connector comprises more than one individual threads.

11. The power module of claim 9, further comprising a power connector insulation tube disposed between the positive terminal of the power connector and the negative terminal of the power connector for providing insulation between the positive terminal of the power connector and the negative terminal of the power connector.

12. The power module of claim 8, further comprising a positive terminal spring of the power connector disposed under the positive terminal of the power connector configured to push the positive terminal of the power connector upwards and to make secure contact with the positive terminal of the vaporizer connector.

13. An electronic cigarette, comprising:
a vaporizer and e-liquid storage tank combo having
a heating element configured to heat e-liquid in direct contact with surfaces of a cylindrical vaporizer, wherein the heating element comprises a positive terminal and a negative terminal; and
a vaporizer connector having a circular base, wherein the circular base comprises an external multiple threads connector and a circular groove; and
a power module having a power connector, wherein the power connector comprises a positive terminal, a negative terminal, and an internal multiple threads connector,
wherein the external multiple threads connector of the vaporizer and e-liquid storage tank combo is threadedly connected to the internal multiple threads connector of the power connector of the power module.

14. The electronic cigarette of claim 13, wherein the vaporizer and e-liquid storage tank combo further comprises:
a circular vaporizer mounting base;
a cylindrical e-liquid storage tank body adapted for storing e-liquid therein;
a cylindrical e-liquid medium disposed inside the circular vaporizer mounting base for providing e-liquid in the cylindrical e-liquid storage tank body to the heating element of the cylindrical vaporizer;
a vaporizer negative terminal contact electrically coupled to the external multiple threads connector for connecting the negative terminal of the power connector of the power module, and the negative terminal of the heating element; and
a vaporizer positive terminal contact electrically coupled to the positive terminal of the power connector of the power module, and the positive terminal of the heating element.

15. The electronic cigarette of claim 14, further comprising a sealing ring disposed between the cylindrical e-liquid storage tank body and the circular groove of the vaporizer connector.

16. The electronic cigarette of claim 13, further comprising a vaporizer insulation tube disposed between the vaporizer negative terminal contact and the vaporizer positive terminal contact for providing insulation between the vaporizer negative terminal contact and the vaporizer positive terminal contact.

17. The electronic cigarette of claim 13, wherein each of the external multiple threads connector of the vaporizer connector and the internal multiple threads connector of the power connector comprises more than one individual threads.

18. The electronic cigarette of claim 13, wherein the external multiple threads connector of the vaporizer connector and the multiple internal treads connector of the power connector have the same number of individual threads.

19. The electronic cigarette of claim 13, wherein the heating element comprises:
one or more mesh heating elements; and
one or more spiral heating elements.

20. The electronic cigarette of claim 13, wherein the cylindrical vaporizer comprises a ceramic vaporizer.
